(19) United States
(12) Patent Application Publication
(10) Pub. No.: US 2022/0292428 A1
(43) Pub. Date: Sep. 15, 2022

(54) SYSTEM AND METHOD FOR IMPROVING SALES FORCE PERFORMANCE

(71) Applicant: Archie Kelly, Lexington, SC (US)

(72) Inventor: Archie Kelly, Lexington, SC (US)

(21) Appl. No.: 17/804,639

(22) Filed: May 31, 2022

Related U.S. Application Data
(63) Continuation-in-part of application No. 16/689,311, filed on Nov. 20, 2019, now abandoned.
(60) Provisional application No. 62/781,812, filed on Dec. 19, 2018.

(51) Int. Cl. G06Q 10/06; G06N 3/02

(52) U.S. Cl. CPC G06Q 10/06375; G06Q 10/06393; G06N 3/02

(57) ABSTRACT

A sales force performance system, particularly in the form of computer software, is used to provide a roadmap to sales teams, including salesperson, managers, executives and owners, to develop best practices and enhance sales metrics within a company or industry. The computer system collects data from sales professionals, including sales people, managers, and executives, assigns numerical values to sales activities, and creates a numerical V value that is provided to a specific customer by the sales force. The system is based on the following equation: V=(R+M+E+Ri−P)×CE. In the equation, the variables have numerical values where V is a score of between 0 and 100, R means relationship, M means monetary benefit, E equals efficiency, Ri is risk, P is a value for pain of change, and CE is a numerical value for customer experience expectation.

### CROSS REFERENCE TO RELATED APPLICATIONS

The present application is a continuation-in-part of U.S. application Ser. No. 16/689,311, entitled System and Method for Improving Sales Force Performance which is a non-provisional of U.S. Provisional Application Ser. No. 62/781,812, entitled System and Method for Improving Sales Force Performance, filed on Dec. 19, 2018. All of the foregoing applications are hereby incorporated by reference in their entireties.

### BACKGROUND OF THE INVENTION

The present invention relates to a system and method for improving the performance of a sales force by collecting data, organizing the data, weighting data points and components, and analyzing the data numerically in order to provide guidance to a sales force, ultimately to provide enhanced value to customers. More specifically, the sales force performance system, particularly in the form of computer software, is used to provide a roadmap to sales teams, including salesperson, managers, executives and owners, to develop best practices and enhance sales metrics within a company or industry.

Many products are commercially available that purport to assist sales people in managing customer relationships, and to help keep track of customer accounts, sales leads, marketing campaigns, and the like. Some of these products also organize customer information, including contacts, email archives, and facilitate information sharing among sales teams, which helps to reduce or eliminate redundancies.

None of these existing commercial products have been particularly successful at focusing the sales team on the six main components that affect sales: 1) Relationships with customers, 2) Total Monetary benefit of products, services and relationship, 3) Efficiencies, 4) Risk Improvement, 5) Pain of Change (minimization) and 6) Customer Experience Expectation. These six factors have proven to be primary drivers of sales, when they are each cultivated properly, in order to bring enhanced value to the customer. Thus, it would be desirable to provide a system that concentrates sales forces on these 6 components or categories, so that each component may be broken down into activities to formulate a scoring process. By categorizing activities of a sales force into these 6 components, and further, by assigning point values to each activity within these 6 components, such a system provides an effective roadmap to creating enhanced value for the customer, which ultimately leads to increased sales volume, profitability, and improved sales team efficiency and performance.

### DESCRIPTION OF THE DRAWINGS

These and other features, aspects, and advantages of the present invention will become better understood with regard to the following description, appended claims, and accompanying drawings where:

FIG. 1 is an example of a screen shot from one embodiment of the present system and method, showing the equation V=(R+M+E+Ri−P)×CE, and further illustrating one example of a weighting scheme for the components, providing examples of activities that fall into each of the six categories of the equation, and indicating a numerical value range (0-5 and 5-0) for each component;

FIG. 2 is a flow chart in spreadsheet format showing a sales person input screen information for one embodiment of the present system and method, where a sales person selects the element or component of the equation, selects an activity, a date, and enters a list of participants and any relevant comments regarding the activity;

FIG. 3 is a flow chart in spreadsheet format showing additional sales person input screen information, where a sales person can establish an estimated value presentation date, and further showing additional information and activities that may be entered for the various components of the equation;

FIG. 4 is an example of a screen shot of information available to a sales person in the form of a ‘dashboard,’ including a list of customers, target value scores, current value scores, the change in value score over the last 30 and 90 days, and the anticipated value presentation date;

FIG. 5 is an example of a screen shot of information available to a sales leader or manager in the form of a ‘dashboard,’ including a list of sales people, their customers, target value scores, current value scores, changes in value scores over the last 30 and 90 days, and anticipated value presentation dates for each customer;

FIG. 6 is another example of a screen shot of information available to a sales leader or manager, showing more specific information about a specific company, including dates of various events, target value score for that customer, current value score for that customer, anticipated value presentation date, the next action or activity scheduled for that customer, and the last action or activity that was completed, as well as an indication that more information is available with regard to each activity;

FIG. 7 is another example of a screen shot of information available to a sales leader or manager, showing the information provided in FIG. 6, and further showing more detailed information about a specific event, which in the current example, was an exploratory call on Sep. 10, 2018;

FIG. 8 is an example of a screen shot of information available to a sales executive in the form of an overview, including a list of sales leaders, their revenue potential and average revenue, and further including for each sales leader a current average value score, a change of that average score over the last 30 days, the total number of prospects, and the total number of prospects having a value scores above 50, 75 and 90;

FIG. 9 is an example of a screen shot of information showing a Sales Executive Dashboard, which includes a summary of information for a specific sales executive for a project, including status information about monetary goals, estimated revenue, average probability of closing, percentage toward goal, the value score, a comparison with other sales executives, and other related information;

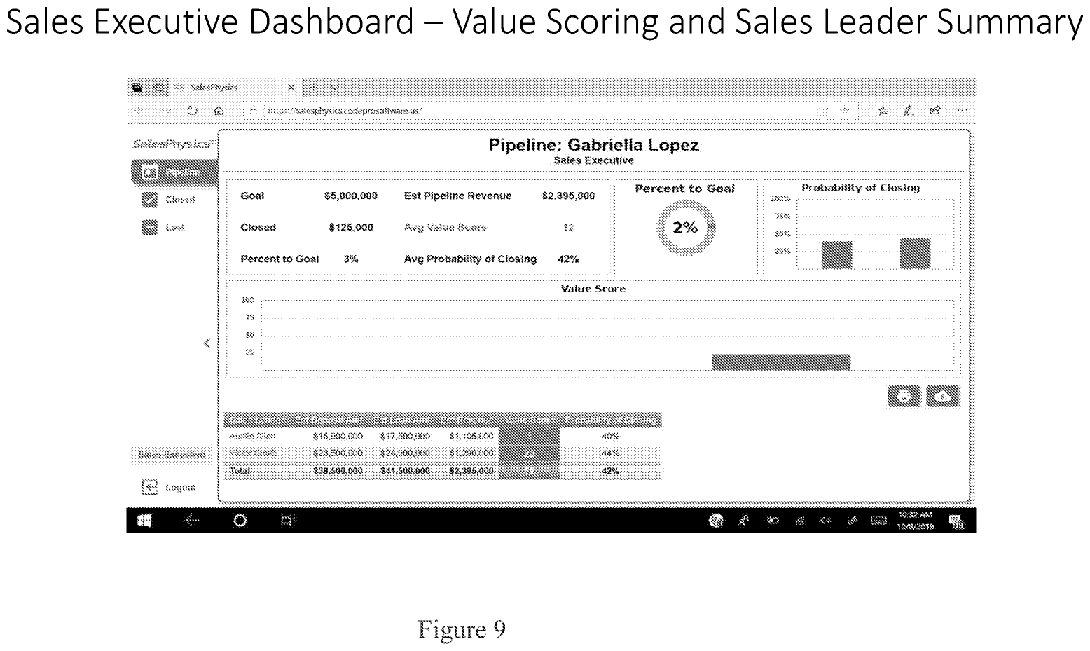

FIG. 10 is another example of a screen shot of information showing a Sales Executive Dashboard, having similar information as shown in FIG. 9, and using a different sales executive in this example;

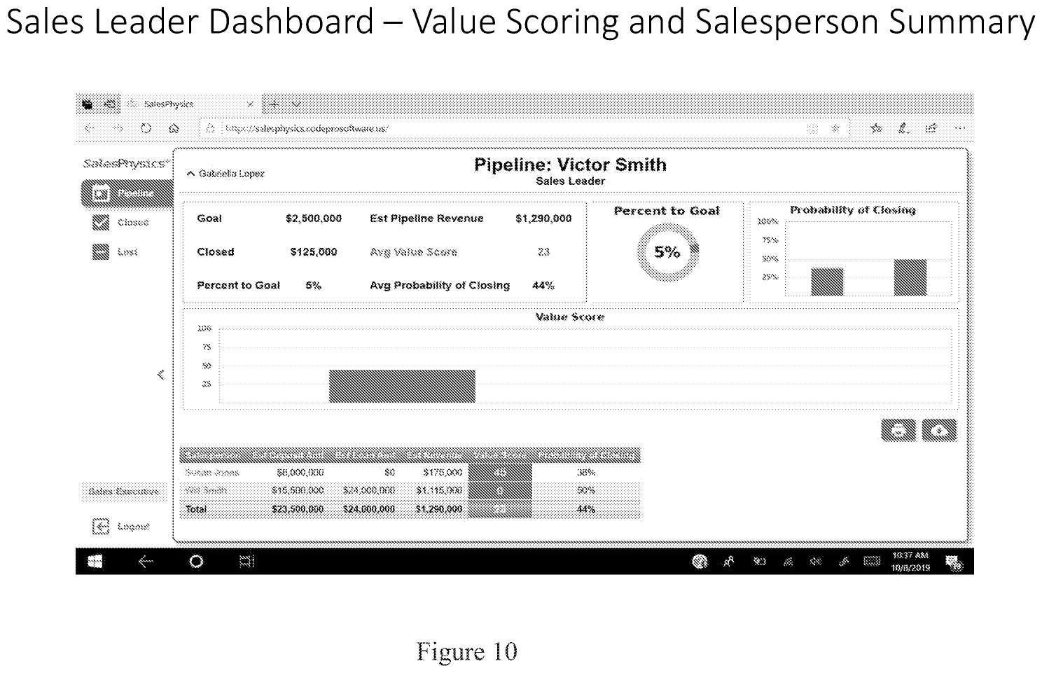

FIG. 11 is an example of a screen shot of information showing a Salesperson Dashboard, which includes a summary of information for a specific salesperson for a project, including status information about monetary goals, estimated revenue, average probability of closing, percentage toward goal, and other related information;

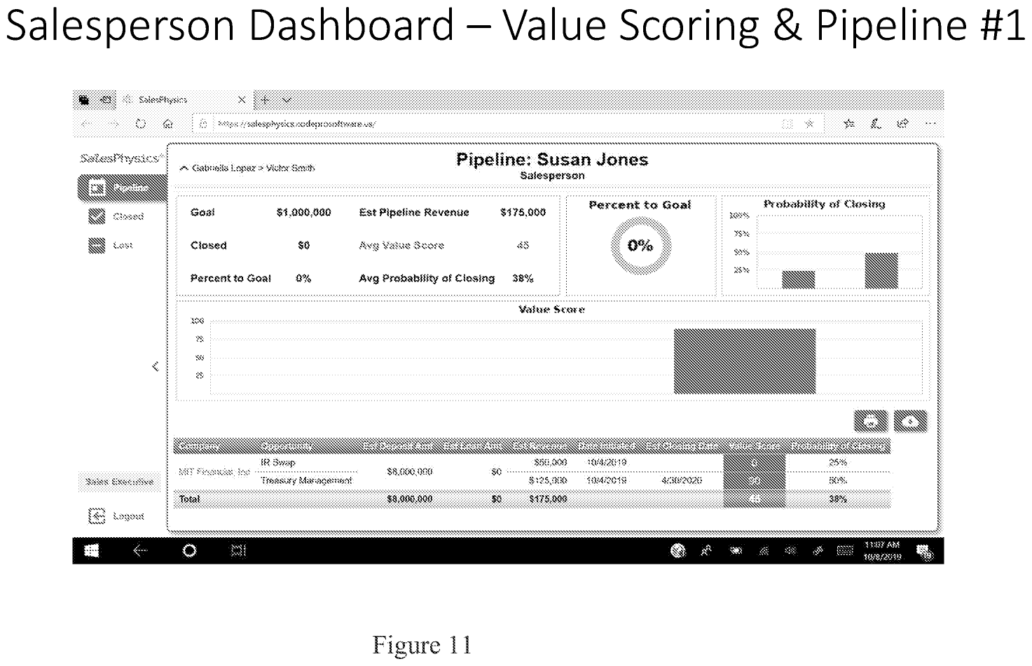

FIG. 12 is another example of a screen shot of information showing a Salesperson Dashboard, having similar information as shown in FIG. 11, and using a different salesperson in this example;

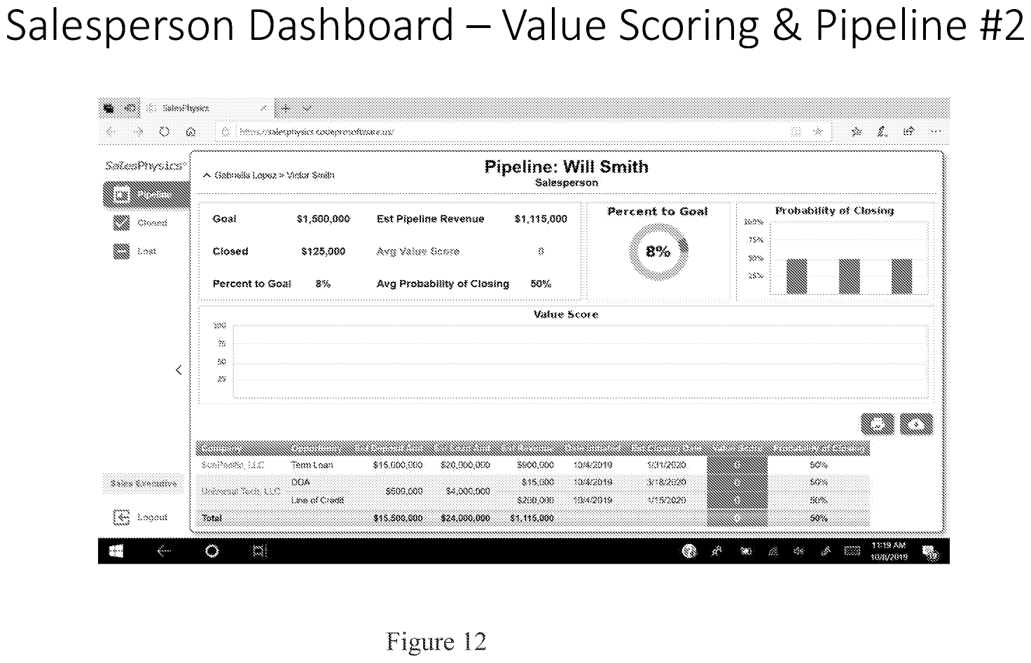

FIG. 13 is an example of a screen shot in one embodiment of the present invention showing Prospect Activity and a Value Scoring screen for a company, which includes a summary of financial information, including an estimated deposit amount, estimated loan amount, estimated revenue, an average value score, probability of closing, and opportunity information, as well as the weighted value equation showing the weighting percentages for each equation variable; and

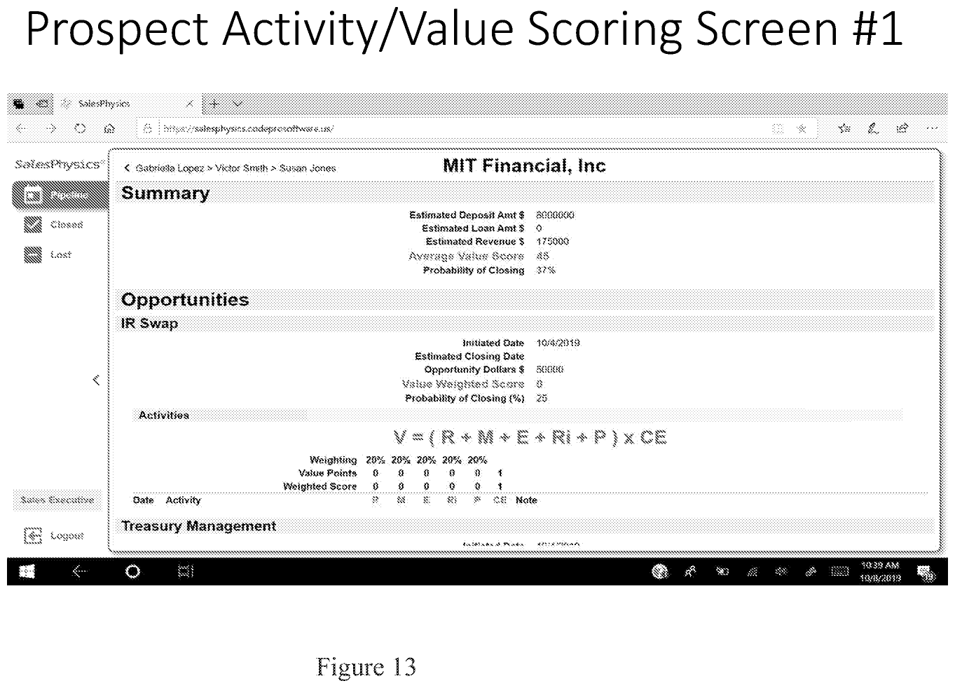

FIG. 14 is an example of a screen shot showing Prospect Activity and a Value Scoring screen for a company, including such information as the initiated date of the project, estimated closing date, opportunity dollars, a value weighted score, a closing probability percentage, the weighted value equation, and notes about activities that have been conducted on specific dates, along with assigned values for each activity.

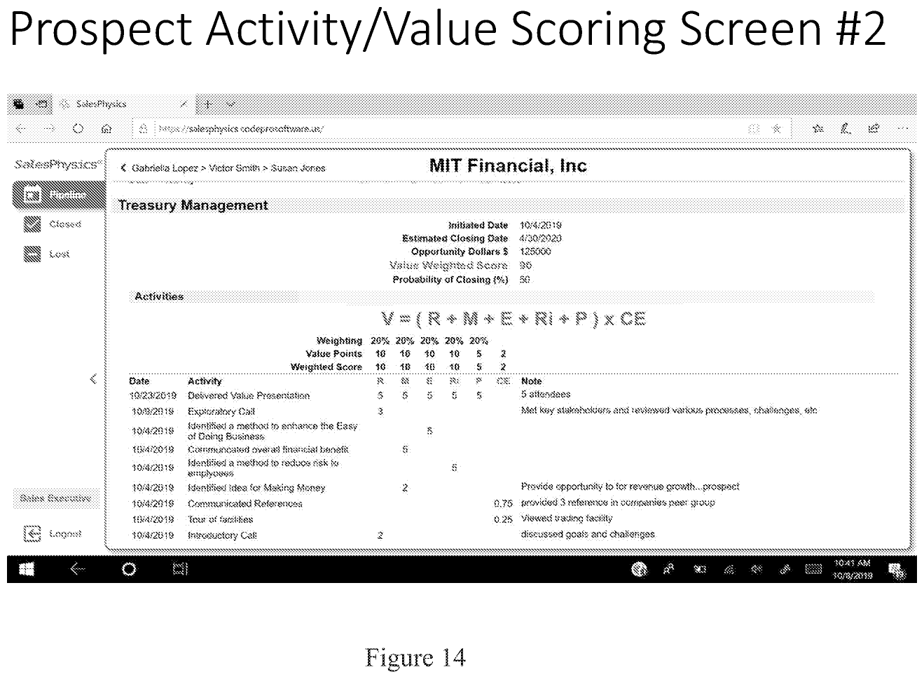

### SUMMARY OF THE INVENTION

In one embodiment, the invention includes a computer system that collects data from sales professionals, including sales people, managers, and executives, and assigns numerical values to sales activities and creates a numerical V value that is provided to a specific customer by the sales force. The system is based on the following equation:

V=(R+M+E+Ri−P)×CE
(also referred to herein as the “equation”)

In the equation, V means value, and for these purposes, V is a numerical value score of between 0 and 100. The other variables or components in the equation are as follows: R means relationship, M means monetary benefit, E equals efficiency, Ri is risk, P is a value for pain, and CE is a numerical value for customer experience expectation. Each of the components of Value (R, M, E, Ri, P and CE) are weighted with a percentage, and the sum of those percentages must equal 100. For instance, one set of weighting values may be as follows: R=30%, M=20%, E=20%, Ri=10%, and CE=10%. The sum of these variables equals 100%. The weighting scheme may be different for every business or industry, and may be altered, as more data is collected and analyzed, in order to provide a more accurate V score for a specific company, industry, or customer.

Each component includes a list of activities, and each activity is assigned a point value. For example, R (relationship) may include the activity of a sales person taking a potential customer to dinner, a sporting event, or any other relationship-building activity. Each time a sales person engages in a relationship-building activity with a customer, the sales person enters that information into the system and that activity is converted into a numerical value, and those cumulative values for relationship-building activities are added together to determine a value for R.

Similarly, activities for each of the other components are recorded in the same way as they happen, converted to numerical values, and then plugged into the equation, taking the weighted values into consideration, in order to provide a numerical V score. Of course, the object is to obtain the highest possible value for V, so that the sales force is engaged in the most efficient activities within each component of the equation, and ultimately, closing deals with customers. By the nature of the equation, the numerical value for V rises over time, as the sales team engages in more activities with a specific customer within the 6 categories of activities (or “components”). It is contemplated that the system may learn, over time, which activities are most efficient and produce the highest V score, and ultimately, the system may offer suggestions to sales teams with respect to which activities they may want to consider next, or in the near future, to boost the V score to a desired threshold.

### DETAILED DESCRIPTION OF THE INVENTION

The present invention includes a system and method for improving sales force performance, preferably in the form of computer or computing device software, based on the following equation:

V=(R+M+E+Ri−P)×CE

The variables (hereafter also referred to as “categories” or “components”) of this equation are as follows:
V=Value (number between 0 and 100)
R=Relationship with customer
M=Monetary Benefit of goods or services

### E=Efficiency

### Ri=Risk Improvement

### P=Pain of Change

### CE=Customer Experience Expectation

As stated above, each of these categories include various activities that the sales team conducts with, or on behalf of, the customer, and each such activity is given a numerical value, as set forth in more detail below. The purpose of this system and method is to focus the sales team on activities that 1) improve customer relationships, 2) show the customer how the products and/or services increase profitability, 3) improve efficiency, 4) lower the customer's risks, 5) decrease the pain of changing to the sales team's products or services, and 6) manage the customer's expectations.

For example, in the R category (relationships), various activities may include taking the customer to a sporting event, lunch, dinner, or coffee. Each of these activities are assigned a point value, and all activities are not equal, so they are assigned points ranging from 0 to 5. Taking a customer to the Super Bowl, for instance, is certainly a more valuable activity than taking him for coffee, so the Super Bowl activity might be worth 5 points, while coffee might be worth 1 point. Each time a member of the sales team engages in one of these activities, he enters that information into the system, under the appropriate category, and either assigns a value to that activity or receives a pre-assigned value that is fed into the equation.

For the M category (monetary benefit), such activities include things like providing a cost/benefit analysis of the products or services, explaining income benefits derived from adopting these products or services, conducting an FTE reduction analysis, or the like. The numerical values are assigned to each activity during the setup phase, or when a new activity is entered into the system, but these values may be changed later to improve the accuracy of the system, if desired.

In the E category (efficiency), activities include showing the customer that the proposed product or service is easier to use, improves time, includes a lower number of steps or is less complicated than their existing process or product.

For the Ri component (risk improvement), the sales team may show how the product or service makes employees safer, for instance, or decreases the chance of loss or fraud.

With respect to the P category (pain of change), the sales team might offer help in making the transition, and explain the plan or process for making the transition to the new product or service. Because this category is essentially a negative component, where the sales team strives to make the pain of change something close to zero, the scale is based on a 5 to 0, where a 5 indicates a higher pain of change value for that activity, and a 0 indicates no discernable pain associated with that activity in making the desired change to the new product or service.

For the CE component (customer experience expectation), activities may include providing a tour of the facility, a demonstration of the system that they are selling, providing an explanation of the customer service process, and similar activities geared toward providing a positive and accurate picture with regard to the customer experience expectation. In this component, the activity points scale ranges from 0 to 5, where a value of 1 is neutral, and a 0 indicates a negative factor.

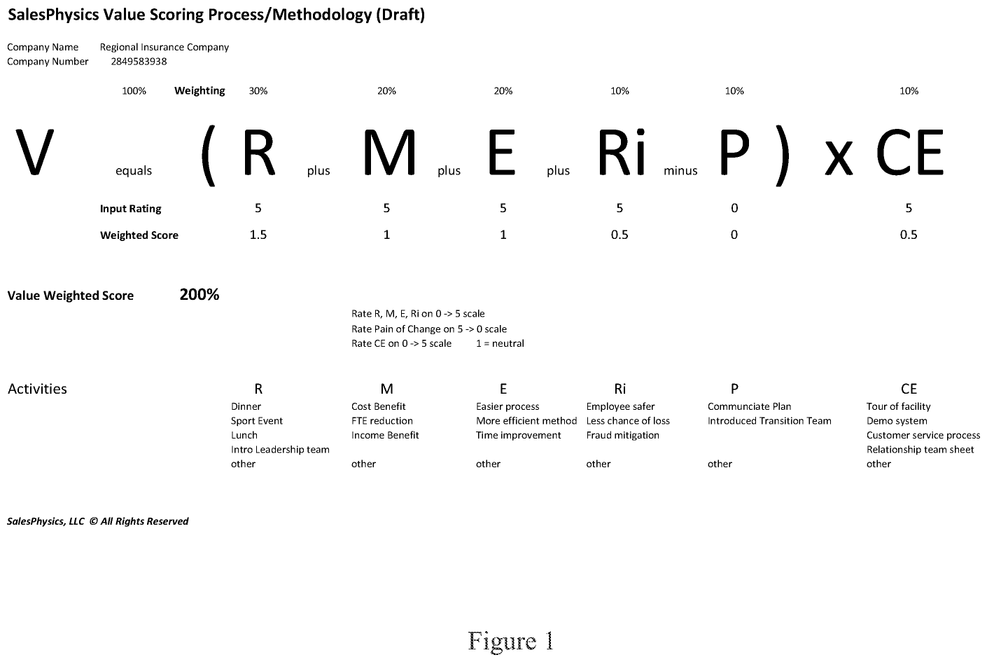

As stated above, each of the components of Value (R, M, E, Ri, P and CE) are weighted with a percentage, and the sum of those percentages must equal 100. For instance, one set of weighting values may be as follows: R=30%, M=20%, E=20%, Ri=10%, and CE=10%, as shown in FIG. 1. The sum of these variables equals 100%. The weighting scheme may be different for every business or industry, and may be altered, as more data is collected and analyzed, in order to provide a more accurate value V for a specific company, industry, or customer. This system is illustrated in spreadsheet form in FIG. 1.

Setup

It is contemplated that software embodying this system and method may be downloaded onto a computer or other device (smart phone, tablet, or the like), a computer network, or may exist on a server in the cloud, so that individual users may access the software remotely. In use, the first step for a user or company is to set various parameters, such as the weighting scheme for the categories, and assigning point values to specific activities. These parameters may start with a default setting, that may then be changed by the user, or more preferably, by users at the executive or management levels of the sales force. In one embodiment, upon installation or initial access of the software, the user is prompted to set up the weighting scheme and the general point values for individual activities. In some cases, a user may also enter additional activities into the system and assign a point value, particularly if such activities are new or unique to a specific customer, business or industry.

Software In Use

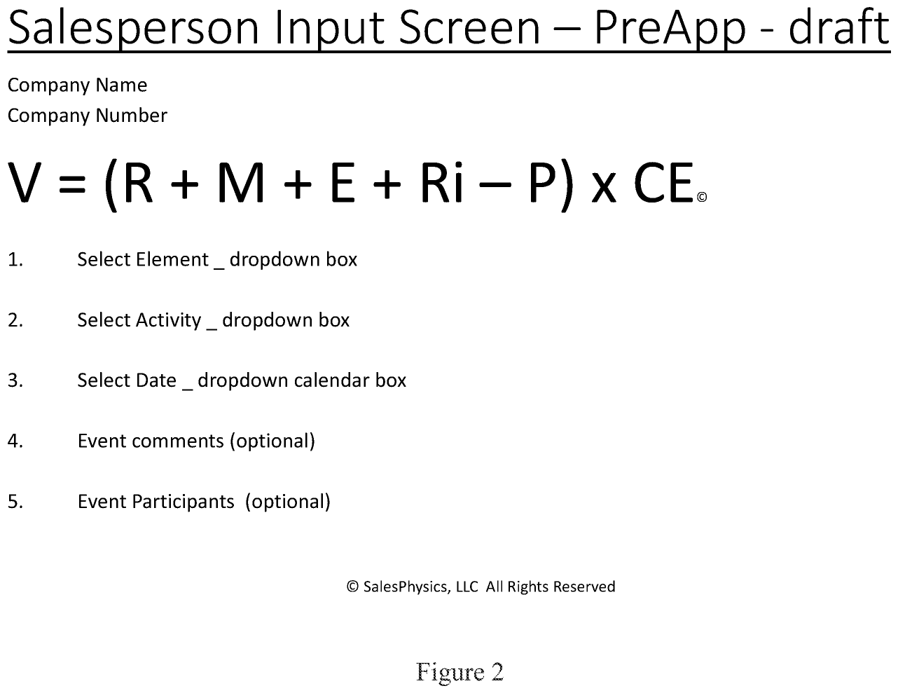

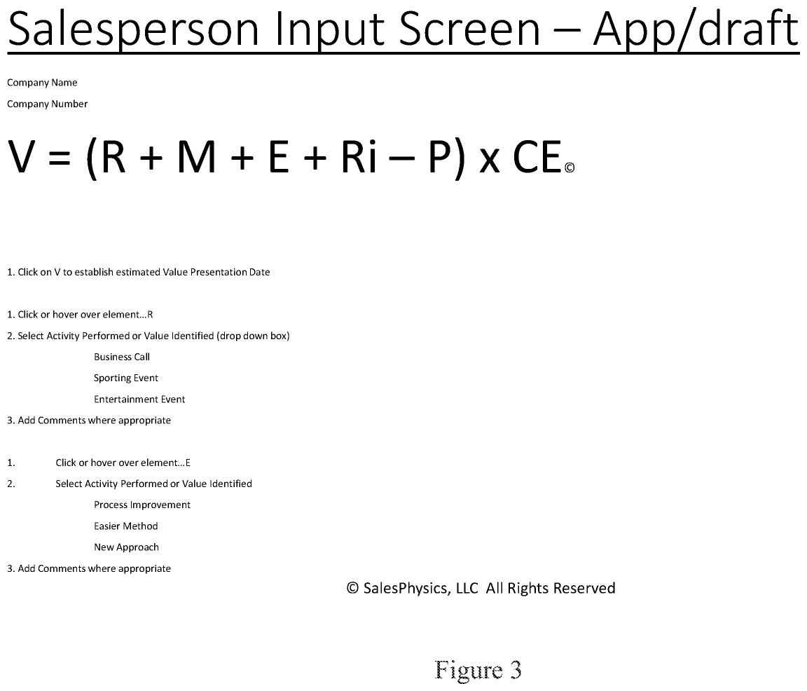

As sales people conduct activities in the 6 categories, they enter each activity into the system, along with any other pertinent information. In one embodiment, the salesperson selects the specific component, and then selects or enters the activity, as well as the date, a list of participants, and any relevant comments. For instance, a sales person may enter an activity of taking a customer out to dinner (including the date and a list or participants), and then provide notes about what was discussed and/or action items that need to be followed up on, as shown in FIGS. 2 and 3. The salesperson may view all of the information that has been entered, to date, for a specific customer or on a particular project. Obviously, as time passes and the sales people have engaged in more activities with, or on behalf of customers, more data populates the system and during this time the V score should rise.

The goal is to steadily raise the numerical V score, until such time as the deal is closed or the sale or transaction has taken place, or alternatively, until the V score goal has been achieved and a presentation may be made to the customer with confidence. Users may go back and look over the data points and overall picture (activities, feedback, etc.) for previously successful deals or transactions, in order to see which activities were most successful, and which ones were not worth the time or effort. Additionally, after the system has been populated with a critical mass of data points, it is contemplated that the system itself may ‘learn’ which activities are most valuable and efficient in closing the deal, and further, may suggest these activities to the user for future reference.

Information Access

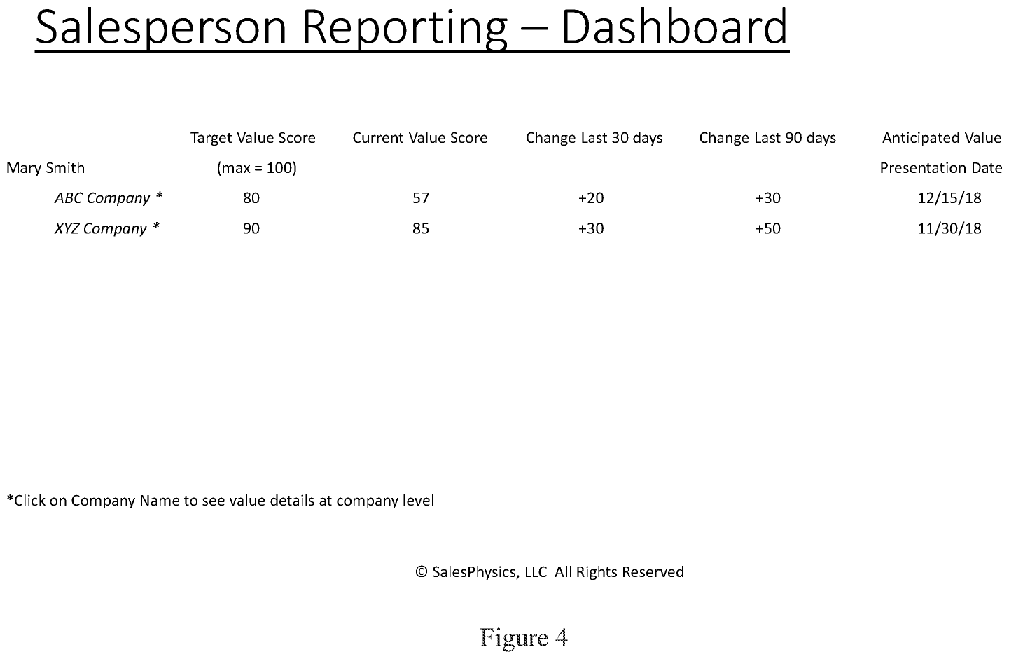

It is also contemplated that specific users may, in some cases, have limited access to the information within the system. For example, a sales person may only have access to the customers that he is working with, but not have access to information or transactions that sales people in other divisions of the company are working on. Sales people will certainly have access to their own customers/projects, a target V score for that customer, the current V score, the change of the V score over the last 30 days or 90 days, and a presentation date, as shown in FIG. 4.

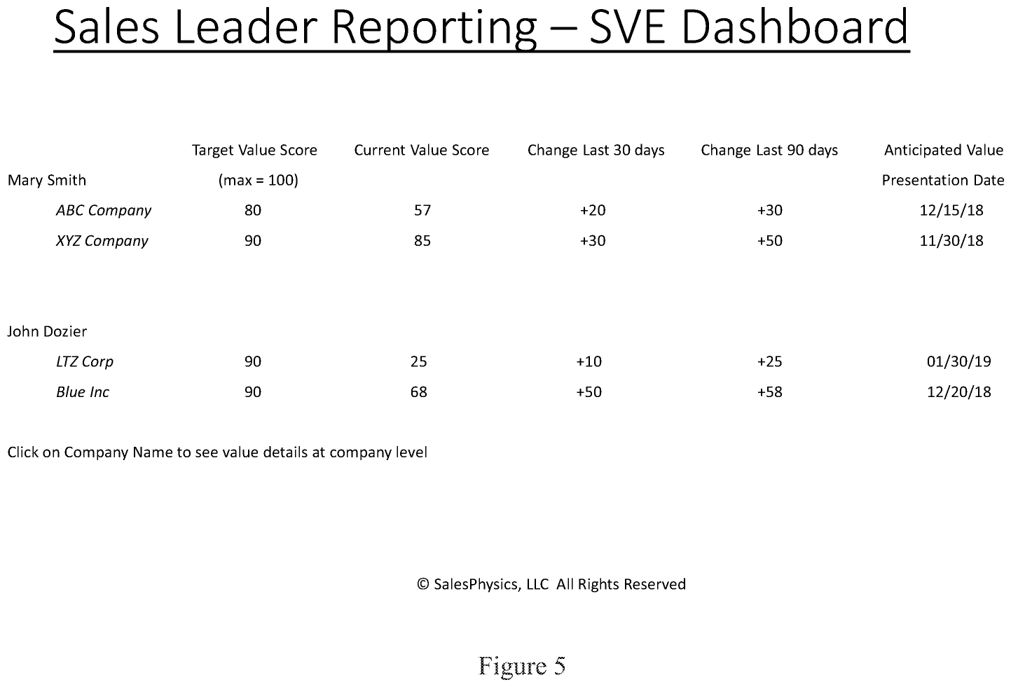

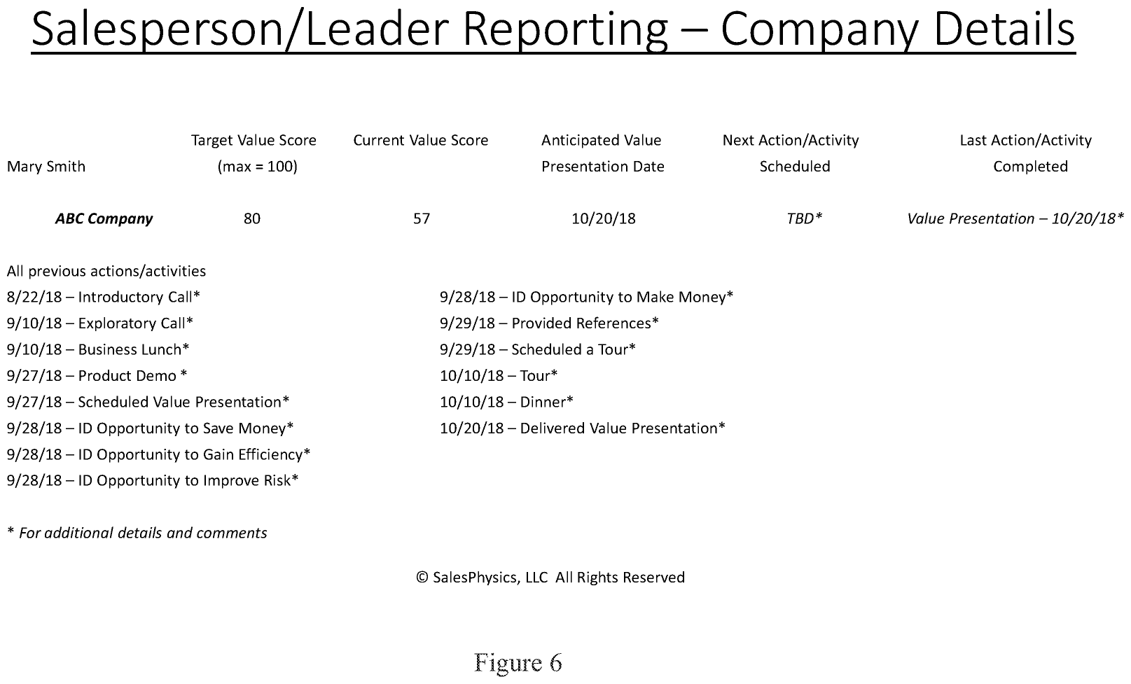

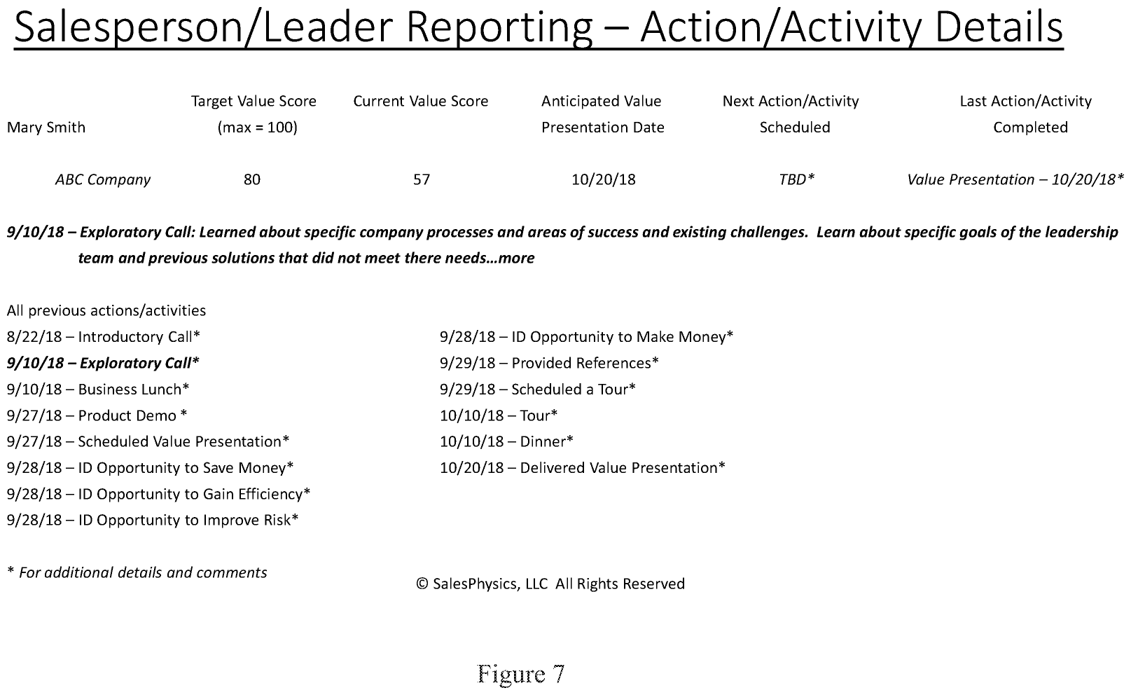

Managers (also referred to herein as “Sales Leaders”) may have greater access, particularly with respect to information generated by the sales force that works directly for them, or for whom they are responsible. Managers may also have more cumulative information across multiple sales people and customers, in order to provide a snapshot-in-time of the performance of their sales teams. For example, a manager will have access to all of the information that his sales people have, and more broadly, will have that information for each of the sales people for whom that manager is responsible, as shown in FIG. 5. A manager may also drill down into the details associated with a particular sales person or customer, in order to see exactly what has transpired with respect to that customer, as shown in FIGS. 6 and 7.

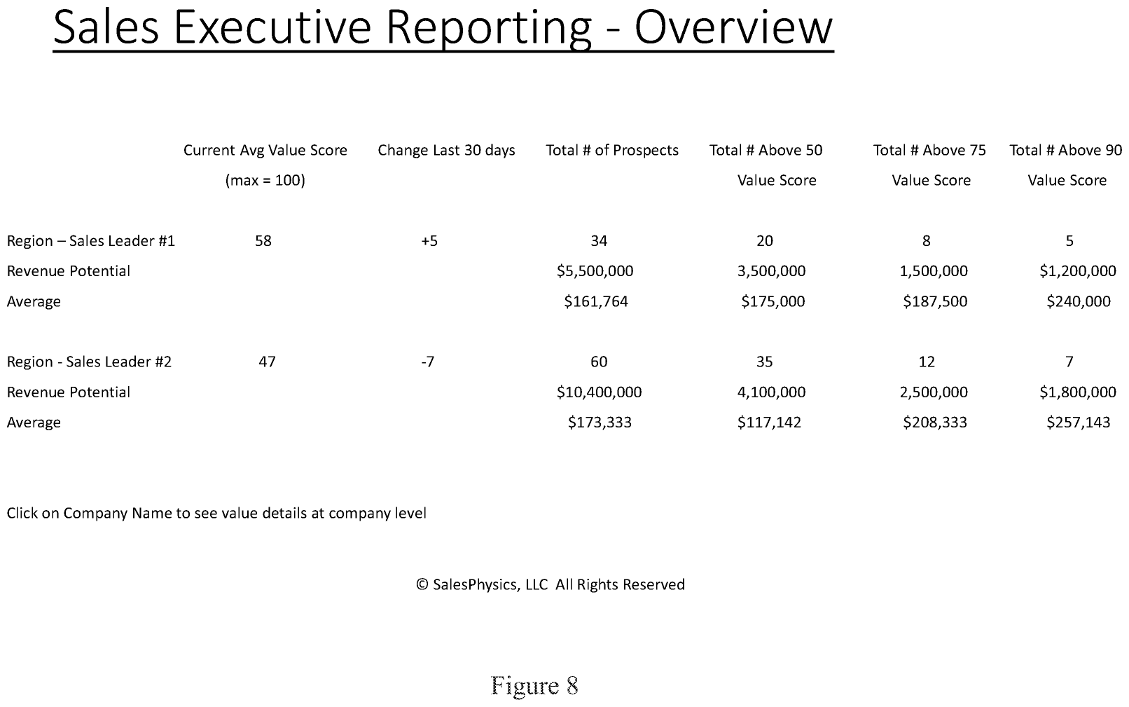

Sales executives, understandably, have the greatest access to system-wide information that affects the company, so that they can form an accurate picture of the overall performance of the sales force, and the company as a whole, as shown in FIG. 8. This information includes the same information as the managers for whom they are responsible, along with executive summary information.

These ‘partitions of access’ within the hierarchy of the company may be set by the sales executives during the initial setup of the software, and sales executives may change those parameters as desired, in order to provide more or less access to the information for specific people or jobs.

Projects and Customers

When a sales person or sales team launches an effort to close a deal with a new customer, an executive or manager may set a goal for the V score within a certain time period, in order to keep the sales team focused on the project and provide deadlines. For instance, the manager may set a goal for the V score to equal 80 within six months from the start date. As the sales person or team engages in the activities set forth within the six categories, they enter that information into the system, and the V score rises, accordingly. If, after three months, the V score is only at 25, then that score is an indication that the sales person or team is behind schedule on achieving their goal, and as a result and armed with that information, they may redouble their efforts in order to get the project back on track to meet the goal.

It is understood that the processes of developing weighting scheme and the numerical values in the 0-5 range associated with each activity are an inexact science, and the system preferably provides the flexibility to modify those schemes and numbers as time passes, based on past experience and a critical mass of data points, to provide a more accurate V score. Further, it should be understood that although the numerical ranges used herein for the variables have been described as V=100 and the other variables have been described as having a range of 0-5, it should be understood that other numerical values may be used for any or all variables in the equation without departing from the spirit and scope of the present invention. For instance, in some embodiments, the values for the CE element are assigned numerical values of between 0-2.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A self-learning system for improving the performance of a sales force with respect to a project for a customer, said system comprising:
a network of computing devices that are programmed to process an equation including variables that correlate with various sales team activities, said variables including V, R, M, E, Ri, P and CE, wherein said equation is V=(R+M+E+Ri P)×CE;
wherein said variable V represents a numerical value between 0 and 100, R is a numerical representation of a relationship with said customer, variable M is a numerical representation of a monetary benefit of goods or services sold by said sales force, variable E is a numerical representation of an improvement in efficiency, variable Ri is a numerical representation of risk improvement of purchasing said goods and services of said sales force in comparison with goods and services previously used by said customer, variable P is a numerical representation of pain of changing to said goods and services sold by said sales force, and variable CE is a numerical representation of customer experience expectation;
said network of computing device is programmed to receive data input for said variables from multiple users within a sales force;
wherein said network calculates numerical values for each variable based on activities conducted in connection with that specific variable so that each activity is assigned a numerical value of between 0 and 5 by each of said multiple users and said numerical value for each variable are equal to a sum of said activity values;
wherein said network calculates a value of variable V based on said numerical values of said variables R, M, E, Ri, P and CE as set forth within said equation; and
wherein said network continually learns to improve its own performance and the performance of said sales force, as additional data inputs are received in real time, by ranking each activity associated with each variable and predicting which future sales activities are most effective to achieve a predetermined desired value for variable V while reducing the amount of time and the number of activities required by said sales force to achieve said predetermined desired value for variable V.

2. The system for improving the performance of a sales force with respect to a project for a customer set forth in claim 1, wherein said network is programmed to allow one or more users to weight each variable R, M, E, Ri, P and CE with a percentage, so that a sum of said weighted variable percentages is equal to 100; and
wherein said network calculates a weighted value for each said variable by multiplying the weighted percentage of each variable by the numerical value for that specific variable.

3. The system for improving the performance of a sales force with respect to a project for a customer set forth in claim 1, wherein said network is programmed to receive and store data input from one or more users in connection with each said activity, including notes about each activity, dates of each activity, and names of participants of each activity; and
wherein said stored data input may be retrieved and viewed at a later time by one or more users.

4. The system for improving the performance of a sales force with respect to a project for a customer set forth in claim 3, wherein said network is programmed with security protocols to allow specific users to retrieve and view all of said stored data input, and to restrict portions of said stored data input from being viewed by other specific users.

5. A method for improving the performance of a sales force with respect to a project for a customer, said method comprising the steps of:
providing a computing device that is programmed to process an equation V=(R+M+E+Ri P)×CE, wherein said variable V represents a numerical value between 0 and 100, R is a numerical representation of a relationship with said customer, variable M is a numerical representation of a monetary benefit of goods or services sold by said sales force, variable E is a numerical representation of an improvement in efficiency, variable Ri is a numerical representation of risk improvement of purchasing said goods and services of said sales force in comparison with goods and services previously used by said customer, variable P is a numerical representation of pain of changing to said goods and services sold by said sales force, and variable CE is a numerical representation of customer experience expectation;
inputting into said computing device a list of activities that are associated with each said variable R, M, E, Ri, P and CE into said computing device so that each said variable is associated with a unique list of activities;
assigning a numerical value to each said activity;
having said computing device add said numerical values of each activity associated with a specific variable together to determine a numerical value for that specific variable;
having said computing device determine a numerical value for the variable V; and
programming said computing device to learn to improve its own performance and the performance of said sales force, as additional data inputs are received in real time, by ranking each activity associated with each variable and predicting which future sales activities are most effective to achieve a predetermined desired value for variable V while reducing the amount of time and the number of activities required by said sales force to achieve said predetermined desired value for variable V; and
having said computing device provide output to said users in the form of predictions of said most effective sales activities to use on current and future projects.

6. The method for improving the performance of a sales force with respect to a project for a customer set forth in claim 5, further including the steps of assigning and inputting a weighted value percentage for each said variable R, M, E, Ri, P and CE, so that a sum of said weighted value percentages is equal to 100; and
having said computing device calculate a weighted value for each said variable by multiplying said weighted percentage of each variable by said numerical value for that specific variable.

7. The method for improving the performance of a sales force with respect to a project for a customer set forth in claim 5, further including the step of inputting and storing data relating to each said activity, including notes about each activity, dates of each activity, and names of participants of each activity so that said activity data may be accessed and viewed at will by users.

8. The method for improving the performance of a sales force with respect to a project for a customer set forth in claim 7, further including the step of implementing security protocols to allow some users to access all of said activity data, and restricting access to a portion of said activity data for other users.
